(19) United States
(12) Patent Application Publication
(10) Pub. No.: US 2004/0146616 A1
(43) Pub. Date: Jul. 29, 2004

(54) Method and system for ultrasonic surface modification of food products

(76) Inventors: James S. Thorson, Scandia, MN (US); Jimmy A. DeMars, Hugo, MN (US); Douglas C. Maniak, Ramsey, MN (US)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 10/353,832

(22) Filed: Jan. 29, 2003

(51) Int. Cl. A23L 3/00

(52) U.S. Cl. 426/238

(57) ABSTRACT

A method of modifying at least one surface of a food product, including the steps of conveying a food product having a first surface along a travel path, urging a first contact element against the first surface of the food product while conveying the food product past the contact element along the travel path, and applying ultrasonic energy to the first contact element while it is being urged against the first surface of the food product, thereby modifying the first surface of the food product. The method may more specifically include the ultrasonic energy being applied to the first contact element at a frequency that modifies the first surface of the food product such that the first surface of the food product that has been conveyed past the contact element is smoother than the first surface of the food product before it is conveyed past the contact element.

### TECHNICAL FIELD

The present invention relates to a method of modifying at least one surface of a dough product. More specifically, the present invention is directed to a method of smoothing the surface of a dough product through the use of ultrasonic energy applied to a contact element.

### BACKGROUND OF THE INVENTION

Conventional dough products are manufactured in many different ways depending on the desired properties of the particular dough product. Some properties of dough products that are often important to consumers include the taste, density, texture, and appearance of the dough products. While some manufacturing processes can provide many of these desirable dough properties in a single step, it is sometimes necessary to use additional processing steps to achieve all of the desired dough properties within a single product.

One process that is commonly used to provide dough products in a wide variety of shapes and sizes is extrusion. Extrusion is a process that can offer an efficient and cost-effective manner of combining several operations into a single processing step performed by a single piece of equipment. Specifically, one extruder may provide some or all of the operations of mixing, cooking, kneading, shearing, shaping, and forming of dough products. Alternatively, an extruder may provide only the function of converting a large volume of dough, such as that provided by a mixer, to a product having a particular shape and size, such as an elongated cylinder of dough. While extruders may vary widely in their method of operation (e.g., cold extrusion or extruder-cookers) and their method of construction (e.g., single- or twin-screw extruders), the principles of operation are similar for most extruders. In addition to extruders, dough may be mixed, blended, and delivered by devices such as pumps and mixers, either alone or in combination with at least one extruder.

One example of a typical prior art extruder 10 is illustrated in FIG. 1. Specifically, multiple raw materials or a dough mixture can be fed into an extruder feed opening 12 of an extruder barrel 14 having a screw apparatus including an elongated screw 16. Alternatively, multiple screws may be used in a single extruder barrel. The dough mixture is typically fed into the feed opening 12 at a controlled rate. In the barrel area nearest the feed opening 12, the elongated screw 16 has a relatively small diameter compared to the interior diameter of the extruder barrel 14 to provide sufficient space between the screw 16 and extruder barrel 14 for receiving a quantity of the dough mixture. This area may also be referred to as the feed area 18. As the screw apparatus rotates, the dough mixture is conveyed by the threads 20 along a travel path 21 away from the feed opening 12. With rotation of the screw 16, the dough continues to move further along the length of the barrel and into the compression area 22. In the compression area 22, the diameter of the screw 16 gradually increases while the interior diameter of the extruder barrel 14 remains constant. Thus, the space between the screw 16 and barrel 14 becomes progressively smaller, thereby restricting the cross-sectional area of the barrel 14 and increasing the resistance to movement of the dough. Depending on the design of the extruder barrel and screw apparatus, this movement of the dough can also provide the additional functions of mixing and kneading the dough, for example.

The dough mixture is then conveyed by the threads 20 of the screw 16 through an area that may be referred to as a metering area 24, in which the distance between the screw 16 and extruder barrel 14 remains relatively constant for movement of dough toward the tapered end of the extruder barrel 14. In the final, converging area 26 of the extruder barrel 14, the extruder barrel becomes progressively smaller in diameter, such that the dough mixture from around the perimeter of the screw 16 converges toward the end 28 of the barrel. Because there are typically no threads in this converging area 26, the dough mixture in this area is pushed toward the end 28 by the pressure of the dough being moved forward by the threads 20 from the areas 18, 22, and 24. When the dough reaches the end 28 of the extruder barrel, it should be sufficiently mixed and processed to provide the various dough properties that are desired for the final dough product. At this point, the dough is forced through one or more restricted openings or dies and discharged from the end 28 of the extruder barrel 14.

As the food emerges under pressure from the extruder openings or dies, the dough mixture is preferably in the desired shape of the final product, such as a cylinder, sphere, tube, strip, or the like. However, the dough product may expand at least slightly to take its final shape after it is no longer under the high pressure typically introduced by the extrusion process. In any case, the final dough product will have various properties that can be adjusted by changing the operating parameters of the extruder and/or by varying the materials that are fed into the extruder.

The type and composition of the materials fed into the extruder and their moisture content and particle size can all influence the viscosity of the dough product and the quality of product that exits the extruder. In fact, different types of feed materials can produce very different products under identical processing conditions within the same extruder. This occurs because differences between the ingredients within a dough mixture can result in final dough products that have different viscosities and flow characteristics from each other. Similarly, the extruder construction and operating conditions can influence various characteristics of the dough products and the quality of the dough products that exit the extruder. Thus, the same ingredients processed by different extruders can provide a final dough product with different properties, depending on the design and operating conditions of that particular extruder.

In the operation of a typical extruder used for dough products, such as the single-screw extruder described above, the dough is pushed or conveyed through the extruder barrel by the motion of a rotating screw apparatus while the pressure on the dough increases. To assist the dough mixture in moving from one end to the other of the extruder, the sides of the extruder barrel may be provided with a surface that causes the dough to stick at least slightly to its sides while the dough typically slips freely from the surface of the screw apparatus. If the dough does not stick at all to the sides of the barrel, it may be difficult to move the dough product from one end of the barrel to the other. However, it is generally undesirable for any surfaces of the barrel to allow the dough product to deposit or build up on the sides of the barrel or to stick within the die openings, since such dough sticking or buildup can influence the consistency and other properties of the dough product that exits the die. In particular, a dough product that sticks to any part of the extruder, particularly a part of the extruder that is near the end from which the dough exits, can have a rough or irregular surface.

While it is typically desirable that the raw materials and operating conditions are optimized within a manufacturing process to consistently extrude materials that meet all of the desired quality standards for the final dough products, it is difficult to achieve this standard. For example, if any of the various properties of the raw or feed materials vary even slightly, the final dough product exiting the extruder can change. Some of these properties that have an important influence on the properties of the dough product include the type of feed materials, the moisture content of the feed materials, the physical state of the feed materials, the amounts and types of starches, proteins, fats, and sugars of the feed materials, and the pH of any moistened materials, for example. In addition, any change in the operating conditions of the extruder environment may also influence the properties of the dough product, such as the temperature and humidity of the manufacturing process, the temperature of the extruder components, and the general condition of the extruding equipment, for example.

One of the visible characteristics of the dough product exiting the extruder that can be influenced by differences in feed materials and extruder operation conditions is the smoothness of the outer surface of the dough product. For some materials, such as bagels, dinner rolls, bread sticks, and bread loaves, it may be desirable that the outer surface of the dough product is generally smooth or even shiny in appearance. Thus, if the outer surface of the dough product that exits the extruder appears rough or dull, the product may have a less desirable appearance to the consumer. In addition, because consumers generally expect that a product will have a consistent appearance each time they purchase that product, if the surface roughness varies significantly throughout the extrusion process, the final product that reaches the consumer can appear quite different depending on when the product is purchased. It is therefore desirable to provide a process and apparatus for smoothing the surface of food products, such as dough products, to achieve a consistent, desirable surface appearance, even if the operating conditions and/or raw materials change. It is further desirable to provide such a process and apparatus for any food products for which it would be beneficial to provide a smoother surface.

### SUMMARY OF THE INVENTION

In one aspect of this invention, a method of modifying the surface of a food product is provided for modifying at least one surface of food products. The methods and system of the present invention are generally intended to provide food products with a more desirable and consistent outer surface than the surface that often results from the processes of manufacturing the food products. The methods and systems of the present invention may be used to smooth surfaces of various types of food products, such as dough products or fruit snacks, for example. In particular, one preferred method of the present invention includes the steps of conveying a food product having at least a first surface along a travel path, urging a first contact element against the first surface of the food product while conveying the food product past the first contact element along the travel path, and applying ultrasonic energy to the first contact element while it is being urged against the first surface of the food product, thereby modifying the first surface of the food product. In particular, the method may include the application of ultrasonic energy to the first contact element at a frequency that modifies the first surface of the food product such that the first surface of the food product that has been conveyed past the first contact element is smoother than the first surface of the food product before it is conveyed past that contact element.

The method may further include a step of applying pressure to the first surface of the food product with the first contact element concurrent with the application of ultrasonic energy to the contact element and may include the step of moving the first contact element relative to the travel path of the food product. In one preferred method of the invention, the conveyed food product has a first average thickness before coming in contact with the first contact element and a second average thickness after that contact element is urged against the first surface of the food product, wherein the first average thickness is greater than the second average thickness.

In another preferred method of the present invention, at least one surface of a food product is modified through the steps of conveying a food product having a first surface along a travel path, urging a contact element against the first surface of the food product while providing relative movement between the food product and the contact element, and applying ultrasonic energy to the contact element while the contact element is being urged against the first surface of the food, thereby modifying the first surface of the food product. This method may further include the step of stopping the conveyance of the food product before urging a contact element against a first section of the first surface of the food product, then again conveying the food product along the travel path after applying ultrasonic energy to the first section of the first surface of the food product.

The methods of the present invention may further include urging a second contact element against a second surface of the food product and applying ultrasonic energy to the second contact element while it is being urged against the second surface of the food product. Additional contact elements may also be used to apply ultrasonic energy to additional food product surfaces, as desired.

In addition, the present invention includes a system for modifying the surface of a food product. The system includes a food product conveying system for moving a food product along a travel path, and a contact element for urging against a first surface of the food product while the element is vibrating at an ultrasonic frequency and while the food is being conveyed along the travel path, thereby modifying the first surface of the food product.

### BRIEF DESCRIPTION OF THE DRAWINGS

The present invention will be further explained with reference to the appended Figures, wherein like structure is referred to by like numerals throughout the several views, and wherein:

FIG. 1 is a front view of a prior art single-screw extruder of the type that can typically be used for extrusion of dough mixtures or products, with the extruder barrel being cut away from the screw portion of the extruder for illustration purposes and therefore is shown in cross-section;

FIG. 2 is a perspective view of a portion of a dough production line including a smoothing assembly;

FIG. 3 is a side view of a portion of a dough processing production line similar to that of FIG. 2;

FIG. 4 is a side view of one embodiment of a horn for use in an ultrasonic system in accordance with the present invention;

FIG. 5 is a front view of a contoured horn tip for use in smoothing dough surfaces that have an outer contour that is similar to that of the horn tip; and

FIG. 6 is a front view of multiple contoured dough pieces of the general shape that may be smoothed by a horn tip of the type illustrated in FIG. 5.

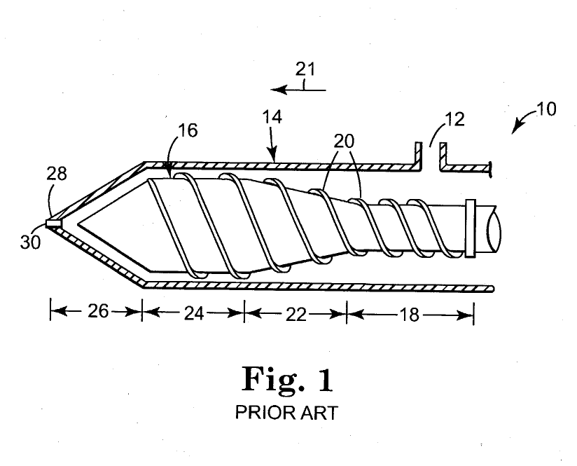

### DETAILED DESCRIPTION OF THE PREFERRED EMBODIMENTS

The present invention is directed to methods and systems for modifying surfaces of food products, particularly dough products that have a relatively rough or irregular surface due to the methods used for processing the dough. However, it is understood that the methods and systems described herein may be applicable to any food products for which a smooth or “finished” surface is desirable, such as fruit snacks, for example. Examples of products that are desirably provided to the consumer with an outer surface that is smooth or even shiny in appearance include bagels, dinner rolls, bread sticks, and bread loaves. Other products may also desirably have a smooth outer surface for more functional purposes, such as providing a smooth surface that can more easily receive additional coating layers. For example, it may be desirable to provide pastries, breakfast foods, and fruit snacks with coating layers such as glazing or chocolate coatings. As discussed in the background, while it is often desirable in the food industry to provide dough products with a consistent, smooth surface appearance, it is sometimes difficult to maintain such product consistency due to small or large variations in the operating conditions and/or raw materials. In addition, when a dough or other food product is processed, such as by extrusion, the outer surface of the product that exits the extruder can often appear rough or dull, thereby providing a product that may have a less desirable appearance to the consumer.

Extrusion is not the only process by which the final appearance of food products can be more irregular than desired. For example, food intermediates (i.e., food products requiring at least one further processing step such as forming, curing, baking, cooking, and the like before they are suitable for consumption) may be provided in a bulk form from a hopper, mixer, pump, or the like to a production line that includes any of a variety of pieces of equipment that manipulate the form of the food product, such as sheeting equipment, a compression roller or series of compression rollers, stamping equipment, or laminating equipment. Contact between the food product and these pieces of equipment can potentially affect the surface roughness of the food product, such as when relatively sticky products contact the surface of processing equipment from which the product does not easily release. In other words, the portions of the food product that stick, at least temporarily, to the surfaces of processing equipment can cause the food product surface to be rough or irregular. However, even if the processing equipment itself does not cause the surfaces to become rough, variations in other material conditions can also contribute to surface roughness, such as the placement of equipment, the quality and consistency of the raw materials, and the amount of manipulation to which the food product is subjected during its processing. For example, dough products that have a high percentage of protein tend to have a more rough surface appearance due to their generally higher strength or toughness as compared to other dough products that have a lower protein content.

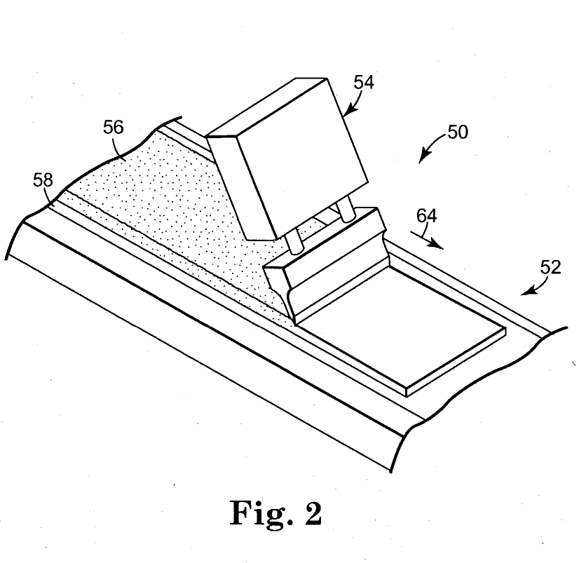

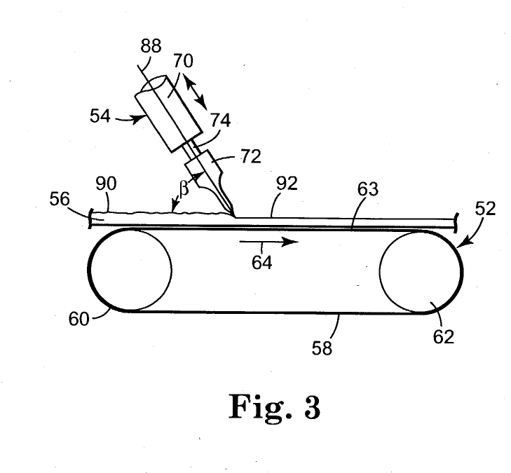

Referring now to the Figures, wherein the components are labeled with like numerals throughout the several Figures, and initially to FIGS. 2 and 3, one preferred configuration of a portion of a dough processing production line 50 is illustrated. Again, where the description herein refers to processing of dough products, it is understood that the methods and systems are equally applicable to other food products that desirably have a relatively smooth surface. The basic equipment of this portion of production line 50 includes a dough conveyor assembly 52 and a smoothing assembly 54. Prior to this illustrated portion of production line 50, the production line could include a variety of equipment and processing steps, where one configuration includes a mixer for combining various ingredients into a dough mixture, a hopper for feeding the dough mixture from the mixer to another piece of processing equipment, and an extruder or other similar machine for manipulating or pumping the dough into a continuous ribbon or sheet of dough material. Additional pieces of equipment may also be used in the production line to process the dough, such as equipment capable of making laminated food products, such as dough sheets, by rolling dough into a sheet and folding the dough sheet over onto itself one or more times.

While this portion of processing production line 50 is shown and described as comprising certain manufacturing and processing equipment, the production line may comprise more, less, or different pieces of equipment prior to the conveyor assembly 52 to produce the desired dough for the present invention. For example, a large bulk quantity of dough may be supplied to an extruder that is capable of extruding dough at a certain thickness and width, after which the dough product may pass through one or more reduction stations until the dough sheet reaches a desired or specified widths and thicknesses.

The dough that enters the area of the conveyor assembly 52 is preferably at a predetermined thickness that is approximately the same or slightly larger than the desired thickness of the final dough sheet or products. This dough sheet 56 may be referred to as a continuous sheet of dough since it is preferably a ribbon or strip of dough that is being continuously extruded, compressed, and/or processed, rather than being provided in discrete or separate sheets. It is contemplated, however, that the methods and processes of the present invention are equally applicable to separate dough sheets. The dough sheet or sheets may have many different material properties, depending on the desired qualities of the final dough products. For example, each sheet of dough may be a single, homogeneous dough material throughout the entire sheet, or may include multiple layers of the same or different food products, such as alternating layers of dough and shortening throughout a single dough sheet. The exact selection of materials and combinations of materials can vary widely, depending on the final desired dough products.

The conveyor assembly 52 of this embodiment includes a conveyor belt 58 formed as a continuous loop of flexible material positioned around first and second conveyor rollers 60, 62. One or both of the rollers 60, 62 may be driven directly or indirectly by a motor to thereby move a top surface 63 of conveyor belt 58 in a travel direction 64. Conveyor belt 58 may be formed of any appropriate material that is sufficiently strong to support both the weight of a moving sheet of dough and also any externally applied forces, without breaking or significantly deforming. A backing roller (not shown) may additionally be used under the belt 58 in the general vicinity of the smoothing assembly 54 to provide supplemental support for the conveyor belt. The belt material should also be sufficiently flexible that it can conform to the diameters of the rollers around which it bends. Examples of such a material include, but are not limited to, a woven nylon or polyester belt, PVC coated fabrics, or fabrics coated with a non-stick substance such as those coatings commercially available under the trade designation “Teflon.” The top surface 63 of conveyor belt 58 may further include one or more coatings that provide the desired amount of friction and release between dough being conveyed and the belt. For example, the belt may include a nonstick coating to prevent or minimize sticking between the belt and the dough sheet. Alternatively, the belt may include a coating material that provides for some friction between the dough sheet and the belt surface, while also providing sufficient release properties so that the dough tends to easily release from the belt. The belt may itself be made of a material that provides these release and frictional properties without any additional coatings, if desired.

The smoothing assembly 54 of this embodiment includes an ultrasonic generator (not shown), a transducer 70, and a horn or contact element 72 attached to the transducer by a collar 74, where these components are discussed in detail below. First, however, the basic functionality of these components in cooperation with each other and relative to a food product in accordance with the present invention will be briefly explained. In particular, the purpose of the smoothing assembly 54 is to modify the top surface of a food product to achieve a certain level of smoothness of the top surface without damaging the structural properties of the food product. Many variations in the components of the assembly and their relationships to each other will affect the performance of the entire smoothing assembly 54, such as the particular horn design, the angle at which the horn is positioned relative to the dough sheet, and the particular frequency at which the horn vibrates, for example. It is preferable that the horn vibrates at an ultrasonic frequency (i.e., greater than or equal to about 20,000 Hz), which thereby prevents sticking of the dough material to the horn. Many of these features of the smoothing assembly 54 can be adjusted to accommodate different food product characteristics so that smoothing assembly 54 can be used with many applications and food products by changing some or all of the operating parameters of the system.

The generator of the smoothing assembly 54 may also be referred to as an ultrasonic frequency generator. In operation, an ultrasonic frequency generator can convert an electrical input (e.g., 60 Hz AC, 117VAC, or 240VAC) to electrical pulses that may be used by other equipment. In particular, the generator of the present invention is preferably connected to transducer 70 that converts electrical pulses received from the generator to mechanical vibrations. In one preferred embodiment of the present invention, the generator of the smoothing assembly 54 converts an electrical input to about 20,000 electrical pulses, which the transducer then converts to about 20,000 mechanical vibrations per second.

The vibrations converted by the transducer 70 are transferred to the horn or contact element 72 so that the horn vibrates at the particular converted frequency (e.g., 20,000 vibrations per second). Preferably, the horn is designed so that the vibrations are concentrated at the tip of the horn while the remainder of the horn stays relatively still. The particular horn used in a smoothing operation is preferably designed or chosen to also have a certain amplitude of vibration to provide the desired amount of smoothing, where this amplitude is at least partially controlled by the geometry of the horn itself Various other types of equipment may be included in the smoothing assembly 54 to control its performance, such as, for example, a booster or reducer (not shown) that can effectively increase or decrease the vibratory movement of the horn, as desired. It is further noted that the horn is preferably constructed of titanium or another similar inert material that is appropriate for use in the food industry with equipment or components that come in contact with food products during processing operations.

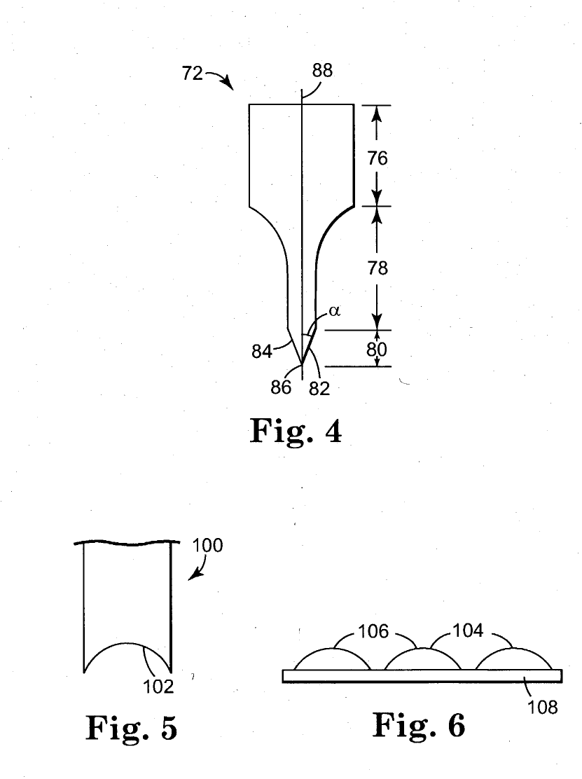

Referring now also to FIG. 4, one embodiment of a horn 72 of the type used in smoothing assembly 54 is shown, which is suitable for smoothing certain dough products in accordance with the present invention. Horns having this general configuration are commercially available from the Dukane Company of St. Charles, Ill. Horn 72 in this particular embodiment may be referred to as a full wavelength horn and comprises a base portion 76, an extending portion 78 that is narrow compared to the base portion 76, and an angled tip portion 80. The term “full wavelength” as used herein and as is understood in the industry, refers to the length of the horn relative to the wavelength of the sound at its operating frequency. The particular portions of the horn 72 are designed to provide particular vibration characteristics. Thus, if it were desired to instead provide a half wavelength horn, the length of the extending portion 78 would be designed to be appropriately shorter than that of a full wavelength horn to provide a particular frequency and amplitude of vibration at the tip portion 80.

As illustrated in FIG. 4, the tip portion 80 includes two angled faces 82, 84 that taper toward each other from the end of extending portion 78 to a tip 86. Angled faces 82, 84 are preferably generally flat or planar surfaces. Although the tip 86 where the faces 82, 84 converge can be relatively sharp, it is generally preferable that the tip 86 be rounded or squared off to minimize the tip breakage that could occur due to the concentration of high frequency vibrations at a sharp point. Alternatively, the tip 86 may have a blunt, tapered, or flat edge. The angled faces 82, 84 are preferably arranged symmetrically about a line 88 that is generally extends along the centerline of the horn 72, where the line extends through base portion 76 to point 86. Thus, the faces 82, 84 are at the same or a similar angle relative to the line 88. In one preferred embodiment, the faces 82, 84 are at an angle α that is in the range of about 5 degrees to about 45 degrees relative to line 88, and more preferably the angle α is in the range of about 10 degrees to about 15 degrees, where the relationship between the angle α and the angle at which the horn or contact element is oriented relative to the dough product is explained in further detail below. This angle (x may also be referred to as the “draft angle” of the tip portion 80. It is understood that the draft angle may be either larger or smaller than those discussed for this embodiment, depending on the particular smoothing operation to be performed. The tip portion 80 is preferably disposed at a draft angle α that is approximately equal to or slightly less than the angle at which the tip contacts the top or upper surface of the food or dough product.

As shown, angled faces 82, 84 are identical to each other and arranged symmetrically about the line 88; however, the face portions may instead be different from each other in various ways, such as their length, contour, arrangement relative to the line 88, depending upon which particular ultrasonic advantages are achieved with a tip portion having a particular design. For example, it may be desirable for one of the angled faces 82, 84 to be generally planar while the other of the face portions is concave, convex, or otherwise contoured, in order to provide certain ultrasonic vibrations at the tip portion 80, and particularly at the surfaces that will come in contact with the dough sheet.

Referring again to FIGS. 2 and 3, one preferred method of smoothing dough is illustrated using a horn of the type shown in FIG. 4. As shown, the smoothing assembly 54 is tilted in a direction that is opposite from the travel direction 64 so that the dough can slide across the faces of the horn without obstruction, thereby smoothing the top dough surface. While the horn may also be tilted in the opposite direction, such an arrangement could facilitate dough buildup on the horn surfaces as the moving dough could essentially push or scrape against the horn surfaces and tip.

In particular, horn 72 is preferably oriented so that it is at a smoothing angle β relative to the direction of travel 64 of the dough and the conveyor. This angle β may either be measured between the centerline 88 of the horn 72 and the top surface 63 of conveyor belt 52, or can be measured between the centerline 88 of the horn 72 and a rough top surface 90 of the dough sheet 56. In either case, the horn is preferably positioned so that at least a portion of one of the angled faces 82, 84 of the tip portion 80 is in contact with the top surface 90 of the dough. To better optimize the amount of dough surface smoothing while avoiding scraping, the horn 72 should be positioned to control the amount of surface area of one of the angled faces 82, 84 that is in contact with the dough sheet. Preferably, the amount of surface area of the face that is in contact with the dough sheet surface is maximized, with no part of extending portion 78 contacting the dough sheet. To accomplish this, the face that contacts the dough is generally parallel with the conveyor belt that is moving the dough sheet. In one preferred embodiment, horn 72 is oriented at an angle β that is in the range of about 5 degrees to about 60 degrees, and more preferably the angle β is in the range of about 15 degrees to about 20 degrees. It is further preferred that the angle β at which the horn is oriented relative to the dough sheet is approximately equal to or slightly larger than the draft angle α of the face portion that contacts the dough surface relative to the centerline of the horn. However, if the angle β at which the horn is oriented relative to the dough sheet is increased to be considerably larger than the draft angle α, the amount of surface area of the horn face portion that contacts the dough will decrease until only the tip 86 contacts the dough sheet. In this case, the tip 86 will likely scrape across the dough surface, which may trim off high points on the surface rather than necessarily provide the desired smoothing function. In addition, the angle β should preferably be large enough that no surfaces of the smoothing assembly contact the dough besides one of the angled faces.

While preferred ranges of draft angles α for the face portions 82, 84 were described above relative to FIG. 4, the draft angle α can preferably be adjusted to achieve a desired smoothing performance with a particular horn configuration. For example, when using a horn having a relatively large draft angle α the angle β at which the horn is oriented relative to the dough surface should also typically be adjusted to provide the desired amount of surface contact between the tip portion and the dough sheet, which in turn will typically provide the desired level of smoothing. Typically, this angle β will then be larger to correspond with the larger draft angle α. For another example, when using a horn having a relatively small draft angle α the angle β at which the horn is oriented relative to the dough surface would be relatively small (i.e., the horn would be oriented so that it is closer to being parallel with the top surface of the dough) to maintain a desired amount of surface contact between one of the face portions of the horn and the dough sheet.

After the dough sheet 56 passes by the smoothing assembly 54, the dough sheet preferably has a top surface 92 that has an acceptable smoothness for that particular product. However, if the dough surface is still somewhat rough, one or more additional smoothing assemblies may be positioned in the production line after the smoothing assembly 54. In this case, the additional smoothing assemblies may be the same or different than the assembly 54, depending on the smoothing performance that is expected from that assembly.

The above-described method can be used to smooth the rough surface of a dough sheet or other food product that is provided in its rough form with approximately the same or a very similar thickness as that desired for the smoothed product. Thus, while the smoothing operation may slightly compress the top surface of the food product, the product may have sufficient elasticity to allow the top surface to spring back after being smoothed so that the thickness of the dough sheet or food product is approximately the same both before and after the smoothing operation. It is also contemplated, however, that the smoothing assembly can apply enough pressure to the food product that it can provide the additional function of reducing the thickness of the product in a controlled manner that does not damage the product. That is, although it may be desired to significantly reduce the thickness of the food product while smoothing its top surface, most products, such as dough products, cannot be reduced in thickness by more than about 33 to about 55 percent in a single compression operation without damaging the structure of the dough. When it is necessary to reduce the thickness of the dough by a greater amount, the dough may be smoothed and/or reduced in thickness with smoothing equipment of the type described in accordance with the present invention in thickness in multiple steps, with each step providing a portion of the thickness reduction. In accordance with the invention, these suggested thickness reduction ranges are only meant to be representative and can vary significantly with dough products having different properties, where dough products have different resistance to damage from compression.

Whether a particular dough sheet is subjected to single or multiple smoothing and/or thickness reducing operations, it is important that the pressure on the dough in each operation is not so low that it skims over the dough surface without adequately smoothing the dough surface. It is equally important that the pressure on the dough is not so high that the horn tip penetrates or damages the dough surface during the smoothing operation. In one example using a bagel-type dough product that is approximately 7/16 inch (1.1 cm) to approximately 9/16 inch (1.43 cm) thick, the preferable pressure on the dough product is in the range of about 5 psi (0.35 kg/cm²) to about 60 psi (4.22 kg/cm²), is more preferably in the range of about 10 psi (0.70 kg/cm²) to about 50 psi (3.52 kg/cm²), and is most preferably in the range of about 25 psi (1.76 kg/cm²) to about 40 psi (2.81 kg/cm²). The acceptable pressure ranges can be considerably higher or lower than these suggested ranges, however, if the dough is particularly tough or delicate.

Again referring to FIGS. 2 and 3, the tip portion 80 of the horn 72 is preferably approximately the same width as the dough sheet 56 that is being smoothed. To provide stability for the tip portion 80, preferably the entire horn 72 is this same width, as illustrated, although it is possible that the necessary stability and support for the tip portion can be provided with horns having a wide variety of configurations. It is further understood that a processing operation may have multiple smoothing assemblies across the width of a single sheet of dough. The multiple smoothing assemblies may be different from each other structurally and/or functionally to optionally provide additional flexibility to smooth various areas of the web differently. For example, the multiple smoothing assemblies could be oriented differently relative to the dough, could include differently configured horns, or may vibrate at different frequencies. Alternatively, the multiple smoothing assemblies could be the same as each other, where the total width of the individual horns preferably is at least as large as the width of the dough that is being smoothed so that the entire width of the dough sheet can come in contact with a horn for smoothing.

While the use of a horn having a generally planar face that contacts and smooths the surface of a dough sheet, this embodiment of horn 72 illustrated in FIGS. 2-4 is only one of many embodiments of a horn within the scope of the present invention. Other configurations of horns that could also be used for smoothing dough surfaces include horns and tips that are generally cylindrical in shape, thereby providing a more curved surface that contacts the dough. In this case, the dough surface being contacted preferably includes concave recesses such that the curved face of the horn tip can fit into those recesses. Other similar arrangements of dough surfaces with mirror image or oppositely shaped contacting smoothing tips are also possible.

One specific example of a shaped smoothing tip that can be used to smooth non-planar dough products is illustrated in FIGS. 5 and 6. FIG. 5 illustrates a shaped smoothing tip 100 having a curved or contoured surface 102, while FIG. 6 illustrates multiple dough strips or pieces 104 on a conveyor belt 108, each strip piece 104 having a top surface 106 that is generally convex. In this embodiment, the surface 102 is generally the same size and shape as the surfaces 106 so that multiple smoothing tips 100 can each be moved across the strips or pieces 104 without significantly deforming them. As in the other embodiments, the ultrasonic vibrations of the tip 100 can minimize or eliminate sticking of the tip to the dough, particularly the vibrations that are concentrated at the surface 102. It is further contemplated that the tip 100 can be moved along more than one axis of movement (e.g., the x-axis and y-axis) to follow the contours of the dough strips or pieces 104. In addition, the tip 100 may also be used to actually change the shape of dough pieces or strips by the application of adequate pressure, if desired.

As an alternative to keeping the smoothing assembly stationary while the dough sheet moves, the dough sheet may be moved or indexed forward along a travel path by incremental amounts with a brief pause period between each subsequent indexing movement. This pause period provides the necessary time for a smoothing assembly including a horn having a smoothing surface to move in a direction that is generally parallel to the top surface of the dough to smooth its top surface. In order to provide the smoothing function, the smoothing assembly is positioned so that the horn is pressed against the top surface of the dough with an adequate pressure to smooth the surface of the dough without damaging the dough structure. The smoothing assembly may move across the dough surface one or more times until the desired smoothness of the dough is achieved. If the smoothing assembly is moved across the dough surface more than once, the smoothing assembly can be moved closer to the dough sheet each time, thereby providing both additional smoothing and thinning of the dough sheet, if desired. The smoothing assembly then moves away from the dough sheet and back to its starting position while the dough sheet is again indexed forward until the next portion of the dough sheet (i.e., the next non-smoothed portion) is properly positioned relative to the smoothing assembly for moving across the next section of dough. This cycle may be repeated multiple times to produce the desired smoothness and thickness of the dough sheet.

A combination of the above described methods may be combined into a single method so that the dough sheet is moving at the same time that the smoothing assembly and horn are moving. In this case, these two operations are coordinated so that the relative movement between the horn and dough it is contacting provides the desired smoothing effect.

It is also contemplated that both the indexing and continuous dough movement methods described above can be used on individual dough pieces, strips, sheets, or the like. In any of these operations, the smoothing assembly could be provided with flexibility to move in multiple directions to contact and smooth all of the desired dough surfaces. Thus, the smoothed dough product may be ready for packaging or baking immediately after the smoothing process, or the smoothed dough may be subjected to further processing and/or converting operations after being smoothed. Other surface processing or treating operations may also be performed on the dough surface after smoothing; however, the process of contacting the dough surface with ultrasonic vibrations can sometimes “set” the dough surface such that it does not readily accept other surface treatments.

The methods and systems of the present invention may further include one or more additional smoothing assemblies positioned to smooth other surfaces of the food product than that described above. Any additional smoothing assemblies may include any of the variations in equipment, components, operating conditions, positions relative to a food product, or other variables described above relative to the smoothing assembly 54. These multiple smoothing assemblies may be positioned to smooth opposite surfaces of a food product, such as top and bottom surfaces, for example. Alternatively, multiple smoothing assemblies may be used to smooth various surfaces that are adjacent or-otherwise oriented relative to each other. For example, one smoothing assembly may contact and modify a top surface of a food product while another smoothing assembly may contact and modify an adjacent side surface of the same food product. When multiple smoothing assemblies are used, each assembly may include the same or similar components as the other assemblies, or the various assemblies may be substantially different from each other to provide different food product surface modifications. That is, it may be desirable for some surfaces to be more or less smooth than other surfaces and/or the various surfaces may exhibit different levels of roughness before smoothing so that some surfaces will require more surface modification to reach an acceptable surface appearance. In addition, the different orientations of the various food product surfaces may necessitate different smoothing assemblies.

When multiple smoothing assemblies are used for different food product surfaces, the multiple operations may take place simultaneously at a single food product smoothing station. In this type of system, multiple food product surfaces may be subjected to ultrasonic vibrations from multiple sources, where the vibrations from adjacent or opposite surfaces may advantageously be utilized to provide a desirable appearance for multiple food product surfaces. Alternatively, multiple smoothing operations may occur sequentially so that only a single food product surface is being subjected to ultrasonic frequency at any one point in the production process. For example, a first food product surface may be smoothed as it is conveyed past a first smoothing assembly, then the food product could be reoriented (e.g., flipped or turned) before another food product surface is smoothed. Such reorientation of the food product may not be necessary, however, even if the smoothing operations occur sequentially.

In one example of a product processed by the methods and systems of the present invention, a typical bagel-type dough product in the 1100 to 1300 B.U. range having a total moisture content of about 30 percent to about 38 percent was extruded by a twin auger stuffer of the type that is commercially available from a number of sources including APV Baker, Inc. of Goldsboro, N.C. and HOSOKAWA BEPEX GmbH of Leingarten, Germany. The dough product was then subjected to approximately 20,000 vibrations per second to create a more smooth or finished surface on the dough product. The dough was then cut into individual bagel products for cooking.

The present invention has now been described with reference to several embodiments thereof. The entire disclosure of any patent or patent application identified herein is hereby incorporated by reference. The foregoing detailed description and examples have been given for clarity of understanding only. No unnecessary limitations are to be understood therefrom. It will be apparent to those skilled in the art that many changes can be made in the embodiments described without departing from the scope of the invention. Thus, the scope of the present invention should not be limited to the structures described herein, but only by the structures described by the language of the claims and the equivalents of those structures.

1. A method of modifying at least one surface of a food product, comprising the steps of:
conveying a food product along a travel path, wherein the food product has at least a first surface;
urging a first contact element against the first surface of the food product while conveying the food product past the first contact element along the travel path; and
applying ultrasonic energy to the first contact element while the first contact element is being urged against the first surface of the food product, thereby modifying the first surface of the food product.

2. The method of claim 1, wherein the ultrasonic energy applied to the first contact element is at a frequency that modifies the first surface of the food product such that the first surface of the food product that has been conveyed past the first contact element is smoother than the first surface of the food product before it is conveyed past the first contact element.

3. The method of claim 1, further comprising a step of applying pressure to the first surface of the food product with the first contact element concurrent with the application of ultrasonic energy to the first contact element.

4. The method of claim 1, further comprising the step of moving the first contact element relative to the travel path of the food product.

5. The method of claim 1, wherein the conveyed food product has a first average thickness before coming in contact with the first contact element, and a second average thickness after the first contact element is urged against the first surface of the food product, wherein the first average thickness is greater than the second average thickness.

6. The method of claim 1, wherein the first contact element comprises a horn.

7. The method of claim 1, wherein the first contact element comprises a surface-modifying tip, wherein at least a portion of the tip is in contact with the first surface of the food product as the food product is conveyed past the first contact element.

8. The method of claim 7, wherein the surface modifying tip is disposed at a draft angle that is equal to or slightly less than an angle at which the tip contacts the first surface of the food product.

9. The method of claim 1, further comprising the step of adjusting the location of the first contact element relative to the first surface of the food product to achieve a predetermined modification of the first surface of the food product.

10. The method of claim 9, wherein the first contact element is adjusted to move the first contact element closer to the first surface of the food product, thereby increasing the pressure against the first surface of the food product.

11. The method of claim 9, wherein the first contact element is adjusted to move the contact element further from the first surface of the food product, thereby decreasing the pressure against the first surface of the food product.

12. The method of claim 1, wherein the urging of the first contact element against the first surface of the food product while applying ultrasonic energy to the first contact element provides a first food surface that is substantially more smooth than before the first contact element was urged against the first surface of the food product.

13. The method of claim 1, wherein the food product further comprises a second surface, the method further comprising the steps of:
urging a second contact element against the second surface of the food product; and
applying ultrasonic energy to the second contact element while the second contact element is being urged against the second surface of the food product.

14. The method of claim 13, wherein the step of applying ultrasonic energy to the first contact element is at least partially completed prior to the step of urging the second contact element against the second surface of the food product.

15. The method of claim 13, wherein the step of applying ultrasonic energy to the first contact element is performed simultaneously with the step of applying ultrasonic energy to the second contact element.

16. The method of claim 1, wherein the food product is dough.

17. The method of claim 1, wherein the food product is a fruit snack.

18. The method of claim 1, wherein the food product has a first thickness as it is being conveyed along the travel path before the first contact element is urged against the first surface of the food product, and wherein the first contact element is sufficiently urged against the first surface of the food to reduce the thickness of the food product from the first thickness to a second thickness.

19. A method of modifying at least one surface of a food product, comprising the steps of:
conveying a food product along a travel path, wherein the food product has at least a first surface;
urging a first contact element against the first surface of the food product while providing relative movement between the food product and the first contact element; and
applying ultrasonic energy to the first contact element while the first contact element is being urged against the first surface of the food, thereby modifying the first surface of the food product.

20. The method of claim 19, wherein the food product is dough.

21. The method of claim 19, wherein the food product is a fruit snack.

22. The method of claim 19, further comprising the step of stopping the conveyance of the food product before urging a first contact element against a first section of the first surface of the food product and further comprising the step of again conveying the food product along the travel path after applying ultrasonic energy to the first section of the first surface of the food product.

23. A system for modifying at least one surface of a food product, the system comprising:
a food product conveying system for moving a food product along a travel path;
a first contact element for urging against a first surface of the food product while the element is vibrating at an ultrasonic frequency and while the food is being conveyed along the travel path, thereby modifying the first surface of the food product.

24. The system of claim 23, wherein the food product is dough.

25. The system of claim 23, wherein the food product is a fruit snack.
